(19) United States
(12) Patent Application Publication
(10) Pub. No.: US 2009/0106463 A1
(43) Pub. Date: Apr. 23, 2009

(54) INFORMATION PROCESSING APPARATUS METHOD FOR PROCESSING DATA

(75) Inventors: Toshitaka Sanada, Oume-shi (JP); Toru Hanada, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/168,760

(22) Filed: Jul. 7, 2008

(30) Foreign Application Priority Data
Oct. 22, 2007 (JP) 2007-274218

(51) Int. Cl. G06F 3/01

(52) U.S. Cl. 710/30

(57) ABSTRACT

An information processing apparatus including: an input unit that allows a user to input operation; an input controller that receives the operation input through the input unit; a data conversion unit that converts console data, which is output from another apparatus used as a serial console, into code data that is recognizable by an operating system; a console data output unit that outputs the console data to the data conversion unit; and a code data output unit that outputs the code data provided by the data conversion unit to the input controller.

### CROSS-REFERENCE TO RELATED APPLICATIONS

This application is based upon and claims the benefit of priority from Japanese Patent Application No. 2007-274218, filed on Oct. 22, 2007, the entire content of which are incorporated herein by reference.

### BACKGROUND

1. Field

One embodiment of the invention relates to an information processing apparatus, such as a personal computer, and a method for processing data, which detect key input from a serial console.

2. Description of the Related Art

Hitherto, an information processing apparatus, such as a personal computer, has been used in various applications, such as document preparation, spreadsheet, and website browsing, and has become widespread for home use and business use. This kind of information processing apparatus is used not only by a single user, but also as a serial console like an information processing apparatus 200, shown in FIG. 6, connected to another information processing apparatus 201 through a serial cable 202 or a network such as a LAN for managing and remotely controlling another information processing apparatus 201. An example of a configuration for such use is disclosed in JP-A-6-075753.

An information processing apparatus is installed with software of an operating system and BIOS (Basic Input/Output System) and operates in accordance with the software. This also applies when the information processing apparatus is used as a serial console. Some operating systems use the keyboard function provided by the BIOS (keyboard control program) and some do not use the keyboard function (for example, a Windows Operating System (registered trademark)).

To use the information processing apparatus 200 as a serial console for managing the information processing apparatus 201, the operating system of the information processing apparatus 201 detects key input (data input using is a keyboard) as follows:

First, it is assumed that an operating system 210 using the keyboard function of the BIOS is installed in the information processing apparatus 201. In this case, if key input t1 from a keyboard of the information processing apparatus 201 occurs as shown in FIG. 7, BIOS 211 executes data acquisition t2 from a data port (not shown) of a KBC (keyboard controller) 212. Next, key code output t3 is performed using the keyboard function of the BIOS 211. Thus, the operating system 210 detects the key input t1 from the keyboard by acquiring the key code using the keyboard function of the BIOS 211.

To determine whether or not key input t4 from the serial console (or the information processing apparatus 200) occurs, the BIOS 211 checks whether or not data from a serial port not shown in FIG. 7 exists (S301 in FIG. 9).

If data exists, a serial controller 213 performs data output t5 and the BIOS 211 receives the data from the serial console (S302).

Subsequently, the BIOS 211 converts the received data into a key code (303). It executes data storage t6 and stores the key code in a key code buffer 214 used by the keyboard function of the BIOS (S304). The operating system 210 executes data acquisition t7 and acquires the key code from the key code buffer 214. Thus, the operating system 210 detects the key input t4 from the serial console by using the keyboard function of the BIOS 211.

Next, it is assumed that an operating system 220 not using the keyboard function of the BIOS is installed in the information processing apparatus 201. In this case, if key input t1 from the keyboard of the information processing apparatus 201 occurs as shown in FIG. 8, a keyboard driver (control program for operating the keyboard) 215 executes data acquisition t8 from the data port of the KBC 212 and performs data output t9 to the operating system 220. The operating system 220 detects the key input t1 by acquiring the data using the keyboard driver 215.

On the other hand, if key input t4 from the serial console occurs, a serial console driver (software) 216 dedicated to serial console input performs data reception t10 from a serial port (not shown) of the serial controller 213 and converts the received data into a key code. The serial console driver 216 executes data output t11 of the key code. Thus, the operating system 220 detects the key input t4 from the serial console by acquiring the key code using the serial console driver 216.

As described above, when the operating system 220 not using the keyboard function of the BIOS is installed, if the serial console driver 216 dedicated to serial console input exists (is installed), the operating system 220 can detect the key input from the serial console.

However, when the serial console driver 216 does not exist, the data input from the serial console cannot be converted into a key code. Accordingly, the operating system 220 cannot acquire a key code either. Thus, the operating system 220 cannot detect the key input from the serial console.

### SUMMARY

One of objects of the present invention is to provide an information processing apparatus and a method for enabling an operating system to detect key input from a serial console if a serial console driver does not exist when the operating system not using a keyboard function of BIOS is installed.

According to a first aspect of the present invention, there is provided an information processing apparatus including: an input unit that allows a user to input operation; an input controller that receives the operation input through the input unit; a data conversion unit that converts console data, which is output from another apparatus used as a serial console, into code data that is recognizable by an operating system; a console data output unit that outputs the console data is to the data conversion unit; and a code data output unit that outputs the code data provided by the data conversion unit to the input controller.

According to a second aspect of the present invention, there is provided a method for processing data in an information processing apparatus provided with an input unit that allows a user to input operation and an input controller that receives the operation input through the input unit, the method including: converting console data, which is output from another apparatus used as a serial console, into code data that is recognizable by an operating system; and outputting the console data to the input controller.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a perspective view to show an appearance of a computer according to an embodiment of the present invention.

FIG. 2 is a block diagram to show an internal configuration of the computer shown in FIG. 1.

FIG. 3 is a drawing to show a configuration wherein the computer according to the embodiment and a computer used as a serial console are connected.

FIG. 4 is a block diagram to show the configuration for detecting key input from a keyboard in the computer according to the embodiment of the invention and key input from a serial console.

FIG. 5 is a flowchart to show an operation procedure to detect key input from the serial console in the computer according to the embodiment.

FIG. 6 is a drawing to show a conventional configuration wherein a computer in a related art and a computer used as a serial console are connected.

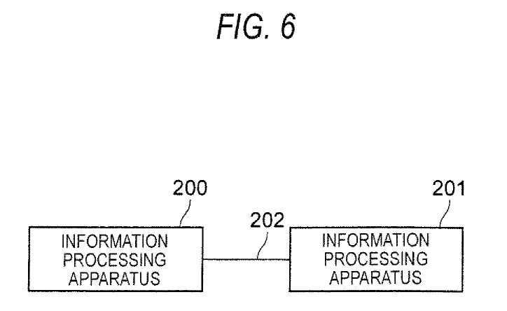

FIG. 7 is a block diagram to show the configuration for detecting key input from a keyboard in the computer in the related art.

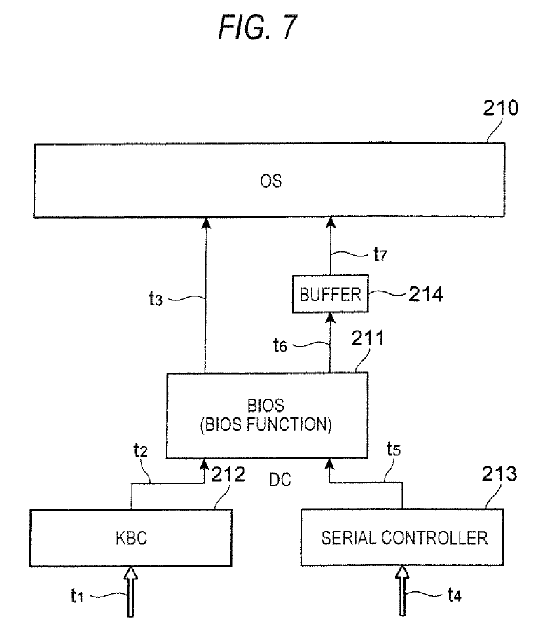

FIG. 8 is a block diagram to show the configuration for detecting key input from a serial console in the computer in the related art.

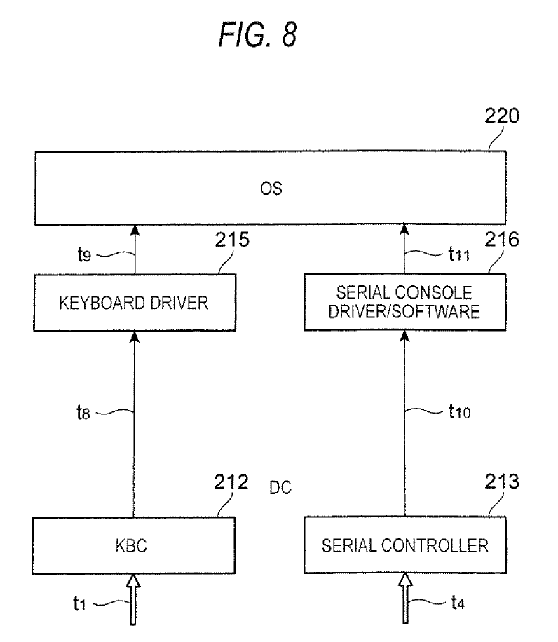

FIG. 9 is a flowchart to show the operation procedure to detect key input from the serial console in the computer in the related art.

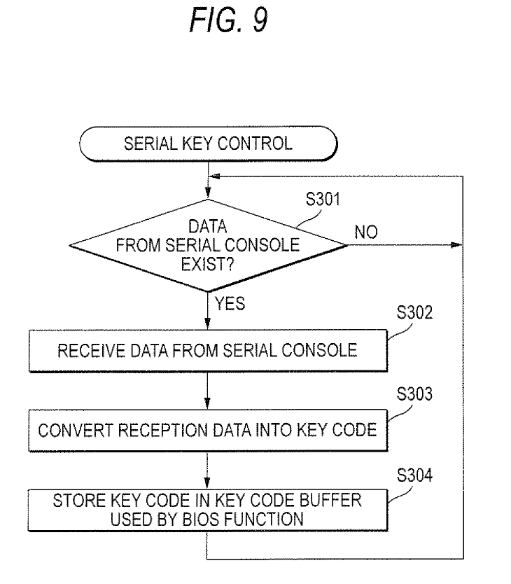

### DETAILED DESCRIPTION

Referring now to the accompanying drawings, there are shown preferred embodiments of the present invention. In the following description, identical components or components having identical functions are denoted by the same reference numerals to omit redundant description therefor.

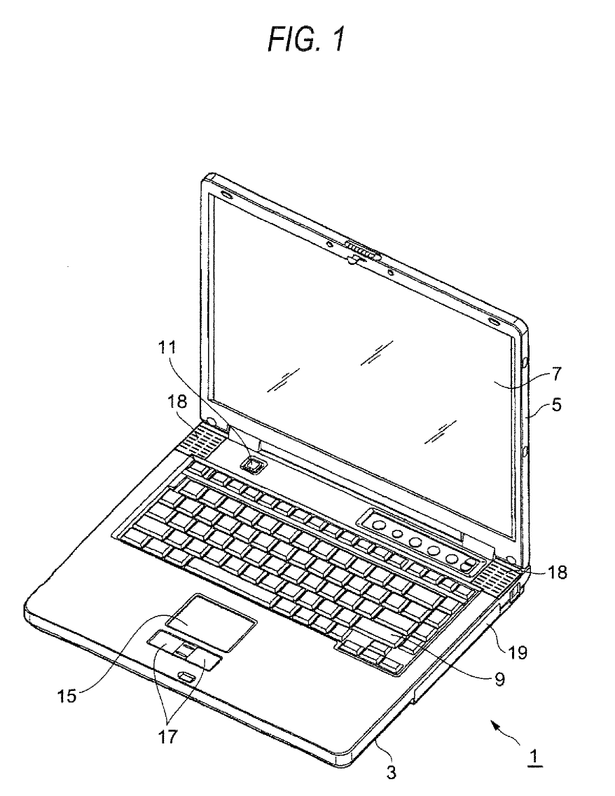

A notebook personal computer (simply, computer) 1 shown in FIG. 1 includes a computer main unit 3 and a display unit 5 that can be opened and closed relative to the computer main unit 3.

A TFT-LCD (Thin Film Transistor Liquid Crystal Display) 7 is built in the display unit 5. The display screen of the LCD 7 is positioned almost in the center of the display unit 5. The LCD 7 is used as a display monitor of the computer 1 for displaying a moving image, a still image, text, graphics, etc.

The display unit 5 is attached to the computer main unit 3 so that the display unit 5 is rotatable between an open position and a closed position. The computer main unit 3 has a thin box-shaped cabinet, and a keyboard 9, a power button 11 for turning on/off power of the computer 1, a touch pad 15, a click button 17, and speakers 18 are placed on the top face of the cabinet.

The keyboard 9 serves as an input unit having keys through which the user performs input operation by pressing any of the keys, thereby inputting data to an embedded controller/keyboard controller IC (EC/KBC) 121 described later.

The keyboard 9 has keys such as an ENTER key, a Back space key, an Insert key, and a Delete key for allowing the user to perform edit operation of input data and predetermined input operation in addition to keys with alphabetic characters and digits engraved on the tops for allowing the user to enter the engraved characters.

The computer 10 reproduces audio video (AV) content (of HD DVD Video standard) stored on a DVD medium of HD DVD standard. A slot 19 for inserting a DVD medium is provided on the front of the computer main unit 3.

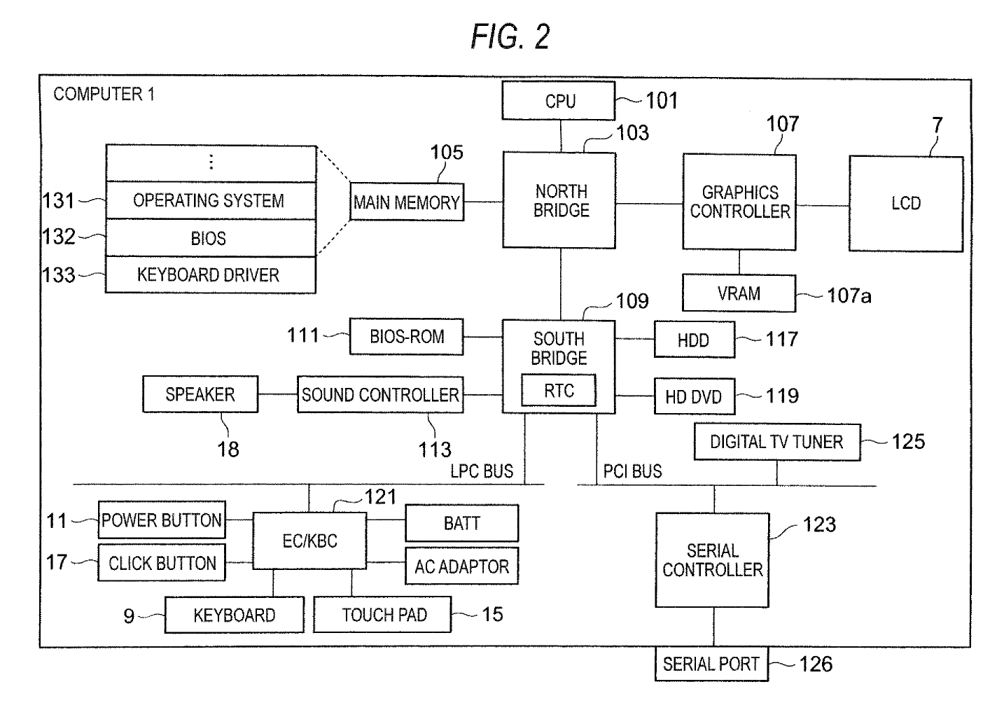

Next, an internal configuration of the computer 1 will be described with reference to FIG. 2. As shown in FIG. 2, the computer 1 has a CPU 101, a north bridge 103, main memory 105, a graphics controller 107, video memory (VRAM) 107a, a south bridge 109, and BIOS-ROM 111.

The computer 1 also has a sound controller 113, a hard disk drive (HDD) 117, an HD DVD drive 119, an embedded controller/keyboard controller IC (EC/KBC) 121, a serial controller 123, a digital TV tuner 125, and a serial port 126.

The CPU 101 is a processor for controlling the operation of the computer 1 and executes programs loaded into the main memory 105 from the HDD 117 and the BIOS-ROM 111. The programs executed by the CPU 101 include not only control programs of an operating system (operating system) 131, BIOS (Basic Input Output System) 132, and a keyboard driver 133, but also application programs such as an HD DVD player application program and TV application.

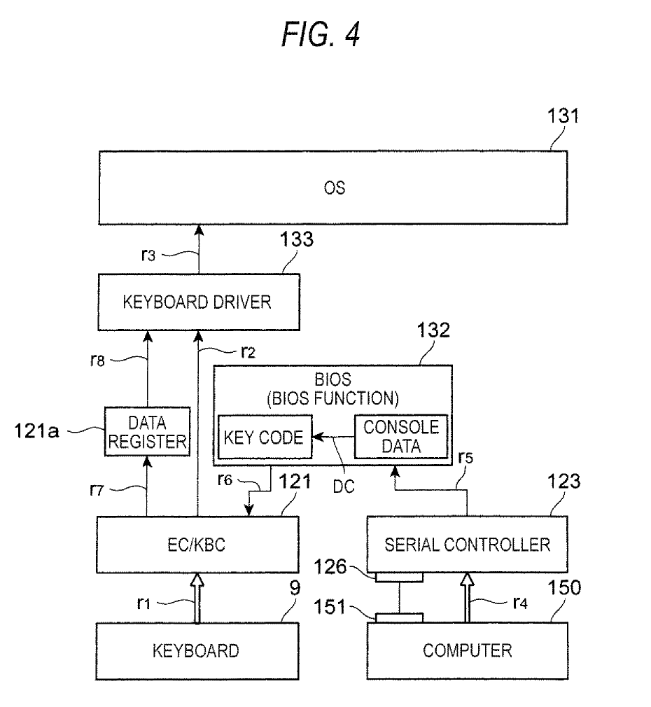

The CPU 101 executes the operation defined in the operating system 131 and the BIOS 132, whereby the functions of various means (data conversion unit, code data output unit) are implemented. The operating system 131 is stored in the HDD 117 and the BIOS 132 is stored in the BIOS-ROM 111. Although described later in detail, the BIOS 132 contains a module for executing data conversion DC shown in FIG. 4 and a module for executing data output r6.

As the operating system 131, an operating system not using the keyboard function of the BIOS 132 (for example, Windows Operating System (registered trademark)) is installed in the computer 1.

The HD DVD player application program is a program for reproducing AV content of the HD DVD Video standard and the TV application is a program for viewing digital TV broadcast.

The north bridge 103 is a bridge device for connecting a local bus of the CPU 101 and the south bridge 109. The north bridge 103 also contains a memory controller for controlling access to the main memory 105. The north bridge 103 also has a function of executing communications with the graphics controller 107 through a serial bus of PCI EXPRESS standard, etc.

The operating system 131 and the BIOS 132 are loaded into the main memory 105.

The graphics controller 107 is a display controller for controlling the LCD 7. The graphics controller 107 has an image processing function to perform various processing, such as blend processing, scaling processing, and luma key processing. A display signal generated by the graphics controller 107 is sent to the LCD 7. The display signal can also be sent to an external TV or HDMI monitor through an interface provided in the computer main unit 3.

The south bridge 109 controls devices on a PCI (Peripheral Component Interconnect) bus and devices on an LPC (Low Pin Count) bus. The south bridge 109 also contains an IDE (Integrated Drive Electronics) controller for controlling the HDD 117 and the HD DVD drive 119.

The south bridge 109 has a function for communicating with the sound controller 113. The sound controller 113 is a sound source device for outputting audio data to be reproduced to the speakers 18.

The embedded controller/keyboard controller IC (EC/KBC) 121 is a one-chip microcomputer wherein an embedded controller and a keyboard controller are integrated. The embedded controller performs power management. The keyboard controller serves as an input controller that receives the operation input through the input unit, the operation such as data input performed by the user using the keyboard 9, the touch pad 15, and the click button 17.

When the user operates the touch pad 15, an operation signal is generated and a cursor displayed on the LCD 7 moves based on the operation signal. The EC/KBC 121 also has a function of turning on/off the power of the computer 1 in response to operation of the power button 11 by the user.

The serial controller 123 controls data transfer in a serial transfer mode. The serial port 126 is connected to the serial controller 123.

The computer 1 includes the digital TV tuner 125 for allowing the user to view digital TV broadcast. The CPU 101 executes the TV application, whereby TV video based on the digital broadcast wave received in the digital TV tuner 125 is displayed on the LCD 7.

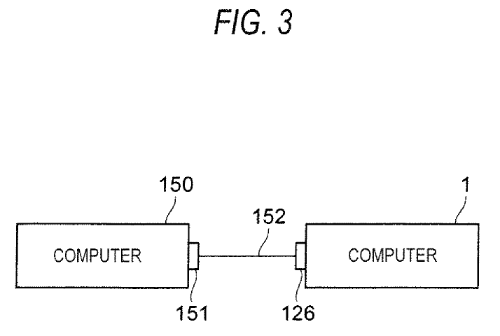

An operation of the computer 1 will be described with reference to FIGS. 3 and 4 for a case where a computer 150 used as a serial console is connected to the described computer 1 and the computer 1 is managed as the user executes key input from the computer 150.

In this case, the computers 1 and 150 are connected as the serial port 126 and a serial port 151 are connected by a serial cable 152 as shown in FIG. 3. Although not shown, the computer 150 has a similar function to that of the computer 1.

As shown in FIG. 4, when key input r1 from the keyboard 9 of the computer 1 occurs, the keyboard driver 133 executes data acquisition r2 from a data port of the EC/KBC 121 and also executes data output r3 to the operating system 131. Thus, the operating system 131 detects the key input r1 from the keyboard 9.

On the other hand, when key input r4 from the serial console (or the computer 150) occurs, the computer 1 performs the following data processing for enabling the operating system 131 to detect the key input r4.

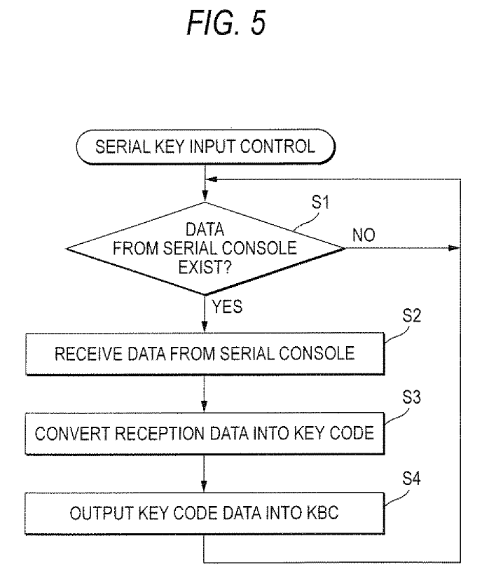

When the power of the computer 1 is turned on, the BIOS 132 is executed if the operating system 131 is not installed. Then, the BIOS 132 performs data presence/absence check processing from the serial port 126 and determines whether or not key input r4 from the serial console occurs (S1 in FIG. 5).

If data exists, the serial controller 123 performs data output r5 and outputs the data from the serial console (also called console data) to the BIOS 132. In this case, the serial controller 123 operates as console data output unit.

Accordingly, the BIOS 132 receives the console data from the computer 150 (S2). The BIOS 132 executes data conversion DOC and converts the received console data into a key code that can be recognized by the operating system 131 (S3).

Next, the BIOS 132 executes data output r6 and outputs the key code to the EC/KBC 121 together with a write command described later.

On the other hand, when the write command is output, the EC/KBC 121 executes data write r7 and writes the key code output together with the write command into a data register 121a. The data register 121a is used as a standard interface for transferring data between data the EC/KBC 121 and the keyboard driver 133.

The keyboard driver 133 is a control program for operating the keyboard 9 and contains a module for executing data acquisition r8 described later and a module for executing data output r3. The CPU 101 operates in accordance with the keyboard driver 133 and the function of code data acquisition unit is implemented.

The keyboard driver 133 executes data acquisition r8 and acquires the key code written into the data register 121a. The keyboard driver 133 executes data output r3 and outputs the acquired key code to the operating system 131. Thus, the operating system 131 uses the keyboard driver 133 to detect the key input r4 from the serial console.

In the related art, a key code can only be acquired from the data port of the EC/KBC 121 by the keyboard driver 133 solely. Thus, when the serial console driver dedicated to serial console input does not exist, if key input r4 from the serial console occurs, the operating system 131 cannot detect the key input r4.

However, in the computer 1 according to the embodiment, when key input r4 from the serial console occurs, the BIOS 132 receives console data from the computer 150 and also converts the console data into a key code and outputs the key code to the EC/KBC 121.

Thus, the computer 1 can perform data processing for the console data as data input in the key input r1 from the keyboard 9.

Therefore, in the computer 1, when the operating system 131 not using the keyboard function of the BIOS 132 is installed, if the serial console driver dedicated to serial console input does not exist, the operating system 131 can detect the key input r4 from the serial console.

The BIOS 132 outputs the key code together with the write command to the EC/KBC 121. The write command is a command for commanding the EC/KBC 121 to write the key code into which the console data is converted according to the key input r4 by the BIOS 132 into the data register 121a.

Thus, when the write command is output, the EC/KBC 121 can write the key code at the time into the data register 121a separate from the data port.

Therefore, the operating system 131 can detect the key input r4 from the serial console by distinguishing the key input r4 from the key input r1 from the keyboard 9.

Not only the key input of the serial console using the serial controller 123, but also a SOL (Serial Over LAN) function of AMT (active management technology) of Intel Corporation for emulating and realizing serial communications involves a problem similar to the problem to be solved by the present invention. However, the problem can also be solved by the present invention.

The description given above is the description about the embodiment of the present invention and does not limit the apparatus or the method according to the present invention. The present invention can be embodied easily as the various forms of modified examples. The present invention may be embodied as an apparatus or a method provided by using the components, the functions, the features, or the method steps as described as the embodiment in appropriate combination.

Although the computer 1 is described as a portable notebook personal computer in the embodiment, the present invention is not limited to the notebook personal computer.

As described above in detail, according to the present invention, there is provided an information processing apparatus and a method for enabling the operating system to detect key input from a serial console if a serial console driver does not exist when the operating system not using the keyboard function of BIOS is installed.

What is claimed is:

1. An information processing apparatus comprising:
an input unit that allows a user to input operation;
an input controller that receives the operation input through the input unit;
a data conversion unit that converts console data, which is output from another apparatus used as a serial console, into code data that is recognizable by an operating system;
a console data output unit that outputs the console data to the data conversion unit; and
a code data output unit that outputs the code data provided by the data conversion unit to the input controller.

2. The apparatus according to claim 1 further comprising:
a code data acquisition unit that acquires the code data from the input controller; and
a data register that is used as an interface between the input controller and the code data acquisition unit.

3. The apparatus according to claim 2, wherein the code data output unit outputs the code data to the input controller together with a write command for writing the code data into the data register.

4. The apparatus according to claim 3, wherein, when the write command is output from the code data output unit, the input controller writes the code data output from the code data output unit into the data register together with the write command.

5. The apparatus according to claim 2, wherein the code data acquisition unit acquires the code data from the data register.

6. The apparatus according to claim 2, wherein the code data acquisition unit is built in a device driver for operating the input unit.

7. The apparatus according to claim 1, wherein the data conversion unit and the code data output unit are built in BIOS for controlling input/output units including the input unit.

8. The apparatus according to claim 1, wherein the input unit is implemented as a keyboard including a plurality of keys.

9. A method for processing data in an information processing apparatus provided with an input unit that allows a user to input operation and an input controller that receives the operation input through the input unit, the method comprising:
converting console data, which is output from another apparatus used as a serial console, into code data that is recognizable by an operating system; and
outputting the console data to the input controller.

10. The method according to claim 9, wherein the code data is output to the input controller together with a write command for writing the code data into a data register used as an interface between the input controller and code data acquisition unit that acquires the code data.
